(19) United States
(12) Patent Application Publication
(10) Pub. No.: US 2007/0069968 A1
(43) Pub. Date: Mar. 29, 2007

(54) High frequency omni-directional loop antenna including three or more radiating dipoles

(76) Inventors: Paul J. Moller, Lake Zurich, IL (US); Boris M. Rubinstein, Deer Park, IL (US)

Correspondence Address: MOTOROLA INC, 600 NORTH US HIGHWAY 45, ROOM AS437, LIBERTYVILLE, IL, 60048-5343, US

(21) Appl. No.: 11/238,945

(22) Filed: Sep. 29, 2005

(51) Int. Cl. H01Q 9/28

(52) U.S. Cl. 343/795; 343/798

(57) ABSTRACT

An omni-directional loop antenna for radiating an electromagnetic signal from a signal source includes a differential feed and at least six radiating elements. The differential feed generates a first signal feed and a second signal feed. The radiating elements include at least three evenly-numbered radiating elements and at least three oddly-numbered elements. Each of the evenly-numbered radiating elements is coupled to the first signal feed and each of the oddly-numbered radiating elements is coupled to the second signal feed. Each of the oddly-numbered radiating elements is reactively coupled to two different ones of the evenly-numbered radiating elements. No two of the first radiating elements are reactively coupled a same pair of second radiating elements.

### BACKGROUND OF THE INVENTION

1. Field of the Invention

The present invention relates to antennas and, more particularly, to omni-directional antennas.

2. Background of the Invention

An Alford loop antenna is typically used in radio navigation systems, such as a VOR system, and in instrument landing systems. An Alford Loop Antenna includes several elements, each of which is driven with a correct ratio of power and at a right phase difference with respect to the other elements of the Array, so that the radiated signal pattern will consist of a RF Carrier, a Sideband Carrier modulated at 90 Hz and the other Sideband Carrier modulated at a selected frequency in space by a process known as space modulation.

The problem with existing four segment (2 dipole) Alford Loop antennas is that their physical size becomes impractically small at the higher frequencies (e.g., greater than 2 GHz). At and above the PCS cellular band the diameter of a practical four segment Alford Loop is about 38 mm. The result is an antenna with segment lengths and segment coupling components that are too small to be tuned practically or adjusted by a human operator.

U.S. Pat. Nos. 2,283,897 and 2,372,651 (issued to Alford) disclose general information about omni-directional antennas and are incorporated herein by reference. U.S. Pat. No. 5,751,252 (issued to Phillips) discloses an omni-directional antenna of reduced size and is incorporated herein by reference.

Therefore, there is a need for an omni-directional loop-type antenna that produces a substantially circular radiation pattern, while having a physical geometry that can be more readily adjusted.

### SUMMARY OF THE INVENTION

In one aspect, the present invention is an omni-directional loop antenna for radiating an electromagnetic signal from a signal source. The antenna includes a differential feed and at least six radiating elements. The differential feed generates a first signal feed and a second signal feed, each corresponding to the electromagnetic signal. The radiating elements each include a first end and a spaced-apart second end. The radiating elements also include at least three evenly-numbered radiating elements and at least three oddly-numbered elements. Each of the oddly-numbered radiating elements is coupled to the first signal feed and each of the evenly-numbered radiating elements is coupled to the second signal feed. Each of the oddly-numbered radiating elements is reactively coupled to two different ones of the evenly-numbered radiating elements. No two of the first radiating elements are reactively coupled to a same pair of second radiating elements.

In another aspect, the invention is an antenna for radiating an electromagnetic signal from a balanced feed signal source that generates a first signal feed and a second signal feed, each corresponding to the electromagnetic signal. The first signal feed is approximately one half wavelength out of phase with the second signal feed. The antenna includes a substantially planar dielectric disc having a first side and a second side. A first radiating member is disposed on the first side and a second radiating member is disposed on the second side. The first radiating member includes a first centrally-located conductive disc and at least three first conductive spokes extending radially from the centrally-located conductive disc. Each first conductive spoke includes a proximal end and a distal end. The proximal end is coupled to the first centrally-located conductive disc. At least three first curvilinear radiating elements, each including a first end and a second end, extend circumferentially from, but are electrically isolated from, a different one of the first conductive spokes. The second radiating member includes a second centrally-located conductive disc and at least three second conductive spokes extending radially from the centrally-located conductive disc. Each second conductive spoke includes a proximal end and an opposite distal end, in which the proximal end is coupled to the first centrally-located conductive disc. At least three second curvilinear radiating elements, each including a first end and an opposite second end, extend circumferentially from, but are electrically isolated from, a different one of the second conductive spokes. Each of the second curvilinear radiating elements is capacitively coupled to two different ones of the first curvilinear radiating elements. No two of the second curvilinear radiating elements is capacitively coupled to a same pair of first curvilinear radiating elements.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a top plan view of one illustrative embodiment of an omni-directional antenna according to one embodiment of the invention.

FIG. 2 is a cross-sectional view of the antenna shown in FIG. 1, taken along line 2-2.

FIG. 3 is an exploded view of a portion of the antenna shown in FIG. 1.

FIG. 4 is a schematic diagram of the antenna shown in FIG. 1.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “spoke” means elongated element that extends radially from a central location and is not intended necessarily to imply any additional meaning involving mechanical behavior.

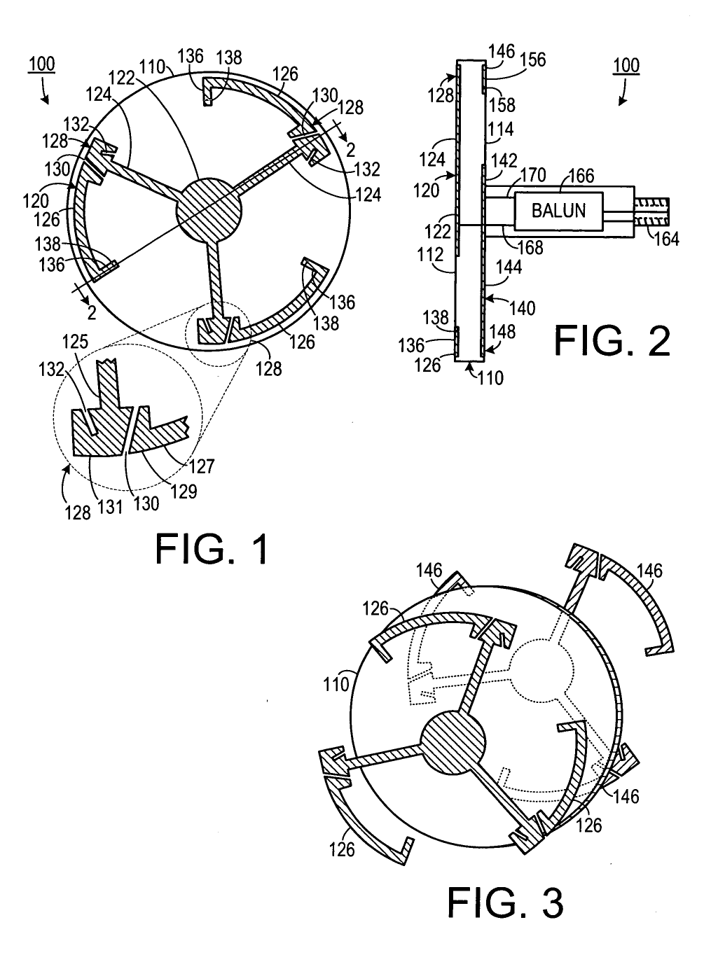

As shown in FIGS. 1-3, one illustrative embodiment of the invention is an omni-directional antenna 100 that radiates an electromagnetic signal from a differential feed signal source 166, which is coupled to the antenna (for example, a balun fed from a coaxial cable 164) and that generates a first signal feed 168 and a second signal feed 170 corresponding to the electromagnetic signal. In at least one embodiment, the differential feed corresponds to a balanced feed produced by a balun, which receives a source signal from a typically unbalanced coaxial feed line. The first signal feed 168 is generally out of phase with the second signal feed 170 by one-half of a wavelength.

The antenna 100 includes a substantially planar dielectric disc 110 that has a first side 112 and an opposite second side 114. A first conductive member 120 is disposed on the first side 112 and a second conductive member 140 is disposed on the second side 114. The first conductive member 120 includes a first centrally-located conductive disc 122 and at least three first conductive spokes 124, each having a proximal end and a distal end relative to the centrally-located conductive disc conductive 122, such that the proximal end of each first conductive spoke 124 is electrically coupled to the conductive disc 122 and each first conductive spoke 124 extends radially from the centrally-located conductive disc 122. A first curvilinear radiating element 126, including a first end and an opposite second end, extends circumferentially from, but is electrically isolated from, each first conductive spoke 124.

Similarly, the second conductive member 140 includes a second centrally-located conductive disc 142 and at least three second conductive spokes 144, each having a proximal end and an opposite distal end. The proximal end of each second conductive spoke 144 is electrically coupled to the conductive disc 142 and each second conductive spoke 144 extends radially from the centrally-located conductive disc 142. A second curvilinear radiating element 146, including a first end and a second end, extends circumferentially from, but is electrically isolated from, each second conductive spoke 144.

Each of the first curvilinear radiating elements 126 is capacitively coupled to a different one of the second conductive spokes 144 and each of the second curvilinear radiating elements 146 is capacitively coupled to a different one of the first conductive spokes 124. In the embodiment shown, the curvilinear radiating elements 126 and 146 are capacitively coupled; however, it is conceivable that they could be inductively coupled. As shown with respect to the first radiating member 120, the each spoke end 128 includes a first sub-region 131 that is in electrical communication with the distal end 125 of a conductive spoke 124 a second sub-region 129 that is in electrical communication with the first end 127 of a curvilinear radiating element 126. The first sub-region 131 is electrically isolated the second sub-region 129 by a non-conductive region 130 (typically an air gap) that isolates the spoke 124 from the curvilinear radiating element 126. The first sub-region 131 may also define a partial gap 132 that facilitates tuning of the antenna. The second radiating member 140 includes a capacitive coupling 148 similar to the one described with respect to the first radiating member 120. The first sub-region 131 coupled to a first spoke 124 (i.e., on the first side 112 of the dielectric disc 110) is capacitively coupled to the corresponding second sub-region 129 coupled to a second curvilinear radiating element 146 (i.e., on the second side 114 of the dielectric disc 110) with the dielectric disc 110 acting as the dielectric of the capacitance. However, because of the non-conductive region 130, there is substantially little or no coupling between the first sub-region 131 and the second sub-region 129 on the same side (e.g., 112 or 114) of the dielectric disc 110.

The second end of each of the first curvilinear radiating elements 126 and of each of the second curvilinear radiating elements 146 terminates in an inwardly-directed extension 136 and 156. The inwardly-directed extension 136 of each of the first curvilinear radiating elements 126 is capacitively coupled to a different inwardly-directed extension 156 of one of the second curvilinear radiating elements 146 to the extent that they overlap on opposite sides of the dielectric substrate 110. In some instances, one or more of the inwardly-directed extensions 136 or 156 may have a portion 138 or 158 removed therefrom, which can effect the corresponding capacitance, which in turn, facilitates tuning of the antenna. As can be seen, each of the first curvilinear radiating elements 126 is paired with a corresponding second curvilinear radiating element 146 at the overlap of the respective inwardly-directed extensions 136 and 156, thereby forming a dipole. Thus, when six curvilinear radiating elements 126 and 146 are used in an antenna 100, the antenna 100 effectively embodies three dipoles.

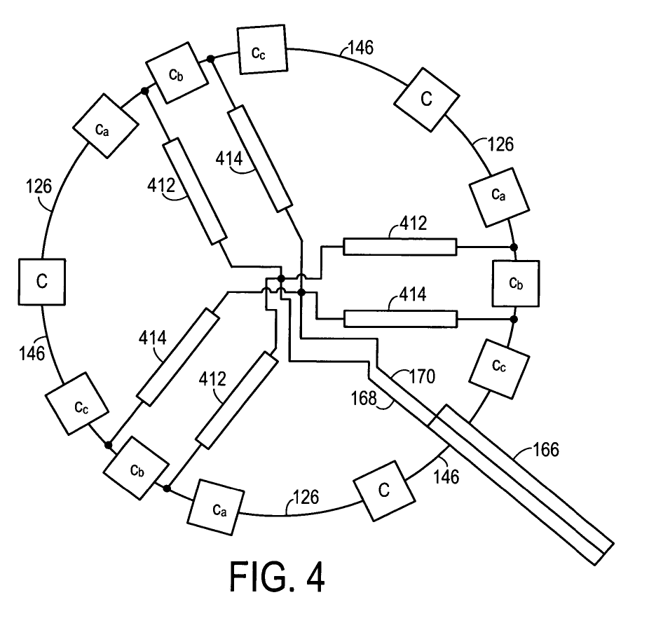

The electrical relationships between the elements are shown in FIG. 4. Each first spoke 124 exhibits a first transmission line impedance 412 with respect to each of the second radiating elements 146 and each second spoke 144 exhibits a second transmission line impedance 414 to each of the first radiating elements 126. As can be seen, an effective capacitance C exists between each first radiating element 126 and each second radiating element 146 at their respective second ends 136 and 156 in view of the portions that overlap. Also, a capacitance cₐ exists between the first signal feed 168 and each corresponding second radiating element 146. Similarly, a capacitance c_{c} exists between the second signal feed 170 and each corresponding first radiating element 126. Also, a capacitance c_{b} exists between the distal end of each first conductive spoke 124 and the corresponding second conductive spoke 144.

While the embodiment shown illustrates the use of six radiating elements 126 and 146, the diameter of the antenna 100 may be made greater for a given transmission frequency by adding still further radiating elements. A greater number of radiating elements would result in the field being more circular. However, as the number of elements increases, the task of tuning the antenna 100 will sometimes become a little more complex. Also, as the number of elements increases, a number of other parameters in the antenna feed structure must change as well. For example, the impedance of the feed lines going to the individual segments must go up accordingly (say from 100 ohms to 150 ohms). Such changes may put a practical upper limit on the number of segments employed as some of the physical dimensions of high impedance transmission lines can become unmanageably small.

Larger embodiments could employ a dielectric disc 110 made of a printed circuit board-like material: smaller embodiments could be made using integrated circuit material.

The embodiments disclosed above use an impedance matching transmission line and a capacitive transformer with or without shunt input capacitor. The equation for matching transmission line is: Z(x-line)=F(Zo, N, radius, Lsegment, Lx-line, Z′ant), where Zo is the output impedance, N is the number of segments employed, Lsegment is the length of each segment, Lx-line is the transmission line inductance and Z′ant is the impedance of the antenna.

The embodiments disclosed above could be especially useful in test labs for mobile devices and antennas. They are also useful in WIFI distribution systems that require omni-directional loop antennas that operate at the higher frequencies (e.g., around 5.2 GHz)

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. An omni-directional loop antenna for radiating an electromagnetic signal, having a wavelength, from a signal source, the antenna comprising:
a. a differential feed that generates a first signal feed and a second signal feed, each corresponding to the electromagnetic signal; and
b. at least six radiating elements each including a first end and a spaced-apart second end, the radiating elements including at least three evenly-numbered radiating elements and at least three oddly-numbered elements, each of the evenly-numbered radiating elements coupled to the first signal feed and each of the oddly-numbered radiating elements coupled to the second signal feed, each of the oddly-numbered radiating elements reactively coupled to two different ones of the evenly-numbered radiating elements wherein no two of the first radiating elements are reactively coupled to a same pair of second radiating elements.

2. The omni-directional loop antenna of claim 1, wherein each of the oddly-numbered radiating elements and each of the evenly-numbered radiating elements is disposed sequentially and peripherally about a geometric shape.

3. The omni-directional loop antenna of claim 1, wherein the geometric shape comprises a circle.

4. The omni-directional loop antenna of claim 1, wherein the first signal feed is capacitively coupled to each of the evenly-numbered radiating elements and wherein the second signal feed is capacitively coupled to each of the oddly-numbered radiating elements.

5. The omni-directional loop antenna of claim 1, wherein the first signal feed is electrically coupled to a first centrally-located conductive area and the second signal feed is electrically coupled to a second centrally-located conductive area that is spaced apart from the first centrally-located conductive area.

6. The omni-directional loop antenna of claim 5, further comprising a first plurality of spokes extending radially outwardly from and electrically coupled to the first centrally-located conductive area and a second plurality of spokes extending radially outwardly from and electrically coupled to the second centrally-located conductive area, each of the first plurality of spokes extending to a different one of the oddly-numbered radiating elements and each of the second plurality of spokes extending to a different one of the evenly-numbered radiating elements.

7. The omni-directional loop antenna of claim 1, further comprising a substantially flat dielectric disc disposed between the oddly-numbered radiating elements and the evenly-numbered radiating elements.

8. The omni-directional loop antenna of claim 1, wherein the differential feed comprises a balun transformer.

9. The omni-directional loop antenna of claim 1, wherein the differential feed comprises a balanced feed.

10. The omni-directional loop antenna of claim 1, wherein an oddly-numbered radiating element and an adjacent evenly-numbered radiating element form a dipole.

11. An antenna for radiating an electromagnetic signal from a balanced feed signal source that generates a first signal feed and a second signal feed, each corresponding to the electromagnetic signal, the first signal feed being approximately one-half wavelength out of phase with the second signal feed, the antenna, comprising:
a. a substantially planar dielectric disc having a first side and an opposite second side;
b. a first radiating member disposed on the first side, the first radiating member including:
i. a first centrally-located conductive disc;
ii. at least three first conductive spokes extending radially from the centrally-located conductive disc, each first conductive spoke including a proximal end and an opposite distal end, the proximal end being coupled to the first centrally-located conductive disc; and
iii. at least three first curvilinear radiating elements, each including a first end and an opposite second end, each extending circumferentially from, but electrically isolated from, a different one of the first conductive spokes; and
c. a second radiating member disposed on the second side, the second radiating member including:
i. a second centrally-located conductive disc;
ii. at least three second conductive spokes extending radially from the centrally-located conductive disc, each second conductive spoke including a proximal end and an opposite distal end, the proximal end being coupled to the first centrally-located conductive disc; and
iii. at least three second curvilinear radiating elements, each including a first end and an opposite second end, each extending circumferentially from, but electrically isolated from, a different one of the second conductive spokes, each of the second curvilinear radiating elements capacitively coupled to two different ones of the first curvilinear radiating elements wherein no two of the second curvilinear radiating elements being capacitively coupled a same pair of first curvilinear radiating elements.

12. The antenna of claim 11, wherein each of the first curvilinear radiating elements is capacitively coupled to a different one of the second conductive spokes and wherein each of the second curvilinear radiating elements is capacitively coupled to a different one of the first conductive spokes.

13. The antenna of claim 11, wherein the distal ends of each of the first conductive spokes is capacitively coupled to a distal end of a different second conductive spoke.

14. The antenna of claim 13, wherein the distal end of each of the first conductive spokes and of each of the second conductive spokes terminates is a conductive region, the conductive region comprising:
a. a first sub-region that is in electrical communication with the distal end of a conductive spoke; and
b. a second sub-region that is in electrical communication with the first end of a curvilinear radiating element, wherein the first sub-region is electrically isolated from the second sub-region.

15. The antenna of claim 14, wherein at least one of the first sub-regions defines a partial gap that facilitates tuning of the antenna.

16. The antenna of claim 11, wherein the second end of each of the first curvilinear radiating elements and of each of the second curvilinear radiating elements terminates in an inwardly-directed extension.

17. The antenna of claim 16, wherein the inwardly-directed extension of each of the first curvilinear radiating elements is capacitively coupled to a different inwardly-directed extension of one of the second curvilinear radiating elements.

18. The antenna of claim 16, wherein at least one of the inwardly-directed extensions has a portion removed therefrom to facilitate tuning of the antenna.
